(19) United States
(12) Patent Application Publication
(10) Pub. No.: US 2010/0165133 A1
(43) Pub. Date: Jul. 1, 2010

(54) IMAGING METHOD, IMAGING DEVICE, AND MANAGING DEVICE FOR MANAGING IMAGES CAPTURED

(76) Inventors: Haoming SHEN, Aichi (JP); Hisashi MITSUYA, Aichi (JP); Yoko TANAKA, Nagano (JP); Masaya OKUMURA, Gifu (JP)

Correspondence Address: MCDERMOTT WILL & EMERY LLP, 600 13TH STREET, N.W., WASHINGTON, DC, 20005-3096, US

(21) Appl. No.: 12/648,129

(22) Filed: Dec. 28, 2009

(30) Foreign Application Priority Data
Dec. 25, 2008 (JP) 2008-330134
Dec. 25, 2008 (JP) 2008-330135
Dec. 25, 2008 (JP) 2008-330136
Jan. 30, 2009 (JP) 2009-020967

(51) Int. Cl. H04N 5/232

(52) U.S. Cl. 348/211.4; 348/E05.042

(57) ABSTRACT

The LOST registration request reception unit acknowledges a direction to cause an imaging device to capture an image and to acknowledge identification information of the imaging device. A device information reception unit acknowledges from the imaging device the identification information of the imaging device via a network. A device information examination unit directs an image to be captured when the identification information acknowledged by the LOST registration request reception unit and the identification information acknowledged by the device information reception unit match. An imaged data reception unit acknowledges the image. An imaged data transmission unit transmits the image.

### CROSS-REFERENCE TO RELATED APPLICATIONS

This application is based upon and claims the benefit of priority from the prior Japanese Patent Applications No. 2008-330134, 2008-330135, 2008-330136, filed Dec. 25, 2008, and No. 2009-020967, filed Jan. 30, 2009, the entire contents of which are incorporated herein by reference.

### BACKGROUND OF THE INVENTION

1. Field of the Invention

The present invention relates to an imaging technology and, more particularly, to an imaging method, imaging device, and managing device for managing images captured.

2. Description of the Related Art

One may sometimes find it difficult to find a lost article that the one owns. One approach proposed to address this is to attach a device to search for a lost article (lost article locating device) to an article owned by one. A lost article locating device is equipped with a Global Positioning System (GPS) for receiving radio waves from a satellite and detecting the current position of the device and is also equipped with communication facilities for communicating over a radio network. A lost article locating device measures the position where the device is and transmits information related to the position using communication facilities. In other words, an article owned by one is searched for based the position as measured by the GPS facilities.

When a user has lost a portable information terminal such as a cell phone terminal or has it stolen, it is desirable that the terminal be prevented from being used by others. One approach to this will be to remote control the lost device to lock its operation or delete the data stored. Where plain text data is stored, the data may be encrypted and stored before being deleted.

If the theft of an article owned by one should be covered instead of the loss of the article, the lost article locating device should be built in the article because the article cannot be located if the article locating device is detached from the article. Most digital cameras owned by users are not equipped with GPS facilities. An additional cost is incurred if a digital camera is equipped with GPS facilities only for the purpose of countering theft or loss. Generally, precision in measurement by GPS facilities is poor indoors.

Since digital cameras are often carried with a user and so are subject to the risk of loss or theft much like cell phone terminals. In digital cameras, images already captured are stored in a recording medium such as a memory card. Thus, images recorded are subject to the risk of being exposed to the view of others as a result of loss or theft. It should be noted that images may be more important to the user than the lost digital camera itself. In other words, there is a demand to have the images back even if the digital camera cannot be recovered.

### SUMMARY OF THE INVENTION

The present invention addresses the challenge and a purpose thereof is to provide a technology capable of estimating the position of a lost article or stolen article, while preventing an increase in the cost and degradation of precision in measurement indoors. Another purpose is to have images stored in a lost imaging device back and to prevent the images from being viewed.

A management device addressing the purpose comprises: a direction input unit adapted to acknowledge a direction to cause an imaging device equipped with communication facilities to capture an image and to acknowledge identification information of the imaging device; an information input unit adapted to acknowledge, from the imaging device equipped with communication facilities, the identification information of the imaging device via a network; a direction output unit adapted to direct the imaging device the identification information of which is acknowledged by the information input unit to capture an image in accordance with the direction to capture an image acknowledged by the direction input unit, when the identification information acknowledged by the information input unit matches the identification information acknowledged by the direction input unit; an image input unit adapted to acknowledge the image from the imaging device directed by the direction output unit to capture an image; and an image output unit adapted to output the image acknowledged by the image input unit.

Another embodiment of the present invention relates to an imaging device. The imaging device is equipped with communication facilities and comprises: an information output unit adapted to output identification of the imaging device to a management device via a network according to a predetermined timing schedule; a direction input unit adapted to acknowledge a direction to capture an image from the management device to which the information output unit outputs the identification information; and an imaging unit adapted to capture an image in accordance with the direction acknowledged by the direction input unit; and an image output unit adapted to output the image captured by the imaging unit to the management device.

Still another embodiment of the present invention relates to a managing method. The method comprises: acknowledging a direction to cause an imaging device equipped with communication facilities to capture an image and to acknowledge identification information of the imaging device; acknowledging, from the imaging device equipped with communication facilities, the identification information of the imaging device via a network; directing, via the network, the imaging device to capture an image in accordance with the direction to capture an image, when the identification information corresponding to the direction to capture an image matches the identification information acknowledged from the imaging device; and acknowledging the image from the imaging device directed to capture an image.

Still another embodiment of the present invention relates to an imaging method. The imaging method is adapted for an imaging device equipped with communication facilities and comprises: outputting identification of the imaging device to a management device via a network according to a predetermined timing schedule; acknowledging a direction to capture an image from the management device to which the identification information is output; and capturing an image in accordance with the direction thus acknowledged; and outputting the image thus captured to the management device.

Still another embodiment of the present invention relates to an imaging device. The imaging device is equipped with communication facilities and comprises: an information output unit adapted to output identification of the imaging device to a management device via a network according to a predetermined timing schedule; a direction input unit adapted to acknowledge a direction to capture an image from the management device to which the information output unit outputs the identification information; and an imaging unit adapted to capture an image in accordance with the direction acknowledged by the direction input unit; and an image output unit adapted to output the image captured by the imaging unit to the management device. The direction to capture an image acknowledged by the direction input unit is generated when it is determined in the management device that the identification information of the imaging device requested to capture an image matches the identification information output from the information output unit, and the image output unit restricts the destination of output of the image to the source of request to capture an image.

Still another embodiment of the present invention relates to an imaging method. The imaging method is adapted to an imaging device equipped with communication facilities and comprises: outputting identification of the imaging device to a management device via a network according to a predetermined timing schedule; acknowledging a direction to capture an image from the management device to which the identification information is output; and capturing an image in accordance with the direction, as acknowledged; and outputting the image as captured to the management device. The direction to capture an image acknowledged by the direction input unit is generated when it is determined in the management device that the identification information of the imaging device requested to capture an image matches the identification information output from the information output unit, and the image output unit restricts the destination of output of the image to the source of request to capture an image.

Still another embodiment of the present invention relates to a managing device. The device comprises: a direction input unit adapted to acknowledge a direction to cause an imaging device equipped with communication facilities to capture an image and to acknowledge identification information of the imaging device; an information input unit adapted to acknowledge, from the imaging device equipped with communication facilities, the identification information of the imaging device via a network; a direction output unit adapted to direct the imaging device the identification information of which is acknowledged by the information input unit to capture an image in accordance with the direction to capture an image acknowledged by the direction input unit, when the identification information acknowledged by the information input unit matches the identification information acknowledged by the direction input unit; an image input unit adapted to acknowledge the image from the imaging device directed by the direction output unit to capture an image; an image processing unit adapted to perform image processing on at least a part of the image acknowledged by the image input unit; and an image output unit adapted to output the image processed by the image processing unit.

Still another embodiment of the present invention relates to an imaging device. The imaging device is equipped with communication facilities and comprises: an information output unit adapted to output identification of the imaging device to a management device via a network according to a predetermined timing schedule; a direction input unit adapted to acknowledge a direction to capture an image from the management device to which the information output unit outputs the identification information; and an imaging unit adapted to capture an image in accordance with the direction acknowledged by the direction input unit; an image processing unit adapted to perform image processing on at least a part of the image captured by the imaging unit; and an image output unit adapted to output the image processed by the image processing unit to the management device.

Still another embodiment of the present invention relates to a managing method. The method comprises: acknowledging a direction to cause an imaging device equipped with communication facilities to capture an image and to acknowledge identification information of the imaging device; acknowledging, from the imaging device equipped with communication facilities, the identification information of the imaging device via a network; directing the imaging device the identification information of which is acknowledged via the network to capture an image in accordance with the direction to capture an image as acknowledged, when the identification information acknowledged via the network matches the identification information acknowledged along with the direction to capture an image; acknowledging the image from the imaging device directed to capture an image; performing image processing on at least a part of the image as acknowledged; and outputting the image subjected to image processing.

Still another embodiment of the present invention relates to an imaging method. The imaging method is adapted for an imaging device equipped with communication facilities and comprises: outputting identification of the imaging device to a management device via a network according to a predetermined timing schedule; acknowledging a direction to capture an image from the management device to which the identification information is output; and capturing an image in accordance with the direction as acknowledged; performing image processing on at least a part of the image as captured; and outputting the image subjected image processing to the management device.

Still another embodiment of the present invention relates to a managing device. The device comprises: a first input unit adapted to acknowledge identification information of an imaging device equipped with communication facilities and subject to monitoring, from a communication device via a network; a second input unit adapted to acknowledge identification information of an imaging device equipped with communication facilities from the imaging device via a network; a direction output unit adapted to cause the imaging device, the identification information of which is acknowledged by the second input unit, to transmit a stored image and then delete the stored image, when the identification information acknowledged by the second input unit matches the identification information acknowledged by the first input unit; an image input unit adapted to acknowledge the image from the imaging device caused by the direction output unit to transmit the image; and a storage control unit adapted to cause the image acknowledged by the image input unit to store the image in a recording medium.

Still another embodiment of the present invention relates to an imaging device. The imaging device is equipped with communication facilities and comprises: an imaging unit; an information output unit adapted to output identification of the imaging device to a management device via a network according to a predetermined timing schedule; a direction input unit adapted to acknowledge a direction to transmit an image captured by the imaging device and stored therein and then to delete the image, from the management device to which the information output unit outputs the identification information; and an image output unit adapted to transmit the stored image to the management device in accordance with the direction acknowledged by the direction input unit; and a deletion unit adapted to delete the image after the image is transmitted from the image output unit.

Optional combinations of the aforementioned constituting elements, and implementations of the invention in the form of methods, apparatuses, systems, recording mediums and computer programs may also be practiced as additional modes of the present invention.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 shows the configuration of the management system according to an embodiment of the present invention;

FIG. 2 shows the configuration of the management device, the imaging device, and the user terminal of FIG. 1;

FIG. 3 shows the data structure of the table stored in the LOST registration management unit of FIG. 2;

FIG. 4 is a sequence chart showing the process performed by the management system of FIG. 1 in the event of a loss of the device;

FIG. 5 is a flowchart showing the process performed by the user terminal of FIG. 2 in the event of a loss of the device;

FIG. 6 is a flowchart showing the process performed by the management device of FIG. 2 in the event of a loss of the device;

FIG. 7 is a flowchart showing the process performed by the imaging device of FIG. 2 in the event of a loss of the device;

FIG. 8 shows the configuration of the imaging device according to the first variation;

FIG. 9 is a flowchart showing the process performed by the user terminal according to the first variation in the event of a loss of the device;

FIG. 10 is a flowchart showing the process performed by the imaging device of FIG. 8 in the event of a loss of the device;

FIG. 11 shows the configuration of the management device according to the second variation;

FIG. 12 is a flowchart showing the process performed by the management device of FIG. 11 in the event of a loss of the device;

FIG. 13 shows the configuration of the management system according to the third variation;

FIG. 14 shows the configuration of the management device, the imaging device, and the user terminal of FIG. 13;

FIG. 15 shows the data structure of the table stored in the LOST registration management unit of FIG. 14;

FIG. 16 is a sequence chart showing the process performed by the management system of FIG. 13 in the event of a loss of the device;

FIG. 17 is a flowchart showing the process by the user terminal of FIG. 14 in the event of a loss of the device;

FIG. 18 is a flowchart showing the process performed by the management device of FIG. 14 in the event of a loss of the device; and

FIG. 19 is a flowchart showing the process executed by the imaging device of FIG. 14 in the event of a loss of the device.

### DETAILED DESCRIPTION OF THE INVENTION

The invention will now be described by reference to the preferred embodiments. This does not intend to limit the scope of the present invention, but to exemplify the invention.

A brief summary of the present invention will be given before describing it in detail. An embodiment of the present invention relates to a management system in which a user terminal, a management device, and an imaging device communicate via a network. An imaging device such as a camera is not equipped with GPS facilities. In this background, the management system according to the embodiment performs the following process to help the user to identify the position of an imaging device lost. When the imaging device is lost, the user transmits the fact that the device is lost (hereinafter, referred to as “LOST information”) to the management device by controlling the terminal. The LOST information includes identification information identifying the imaging device (hereinafter, referred to as “ID”).

The management device registers the imaging device as a target of monitoring by receiving the LOST information (hereinafter, referred to as “LOST registration”). The imaging device transmits the ID to the management device via the network when the device is started. Upon receipt of the ID, the management device verifies whether the ID is registered in LOST registration. When the LOST registration is made, the management device directs the imaging device to perform an operation to counter the event of loss (hereinafter, referred to as loss protection operation). The imaging device receiving the direction capture images periodically and transmit the images to the management device. In other words, the imaging device uploads images to the management device. The management device transmits images in accordance with a request from the user. The user estimates the position where the imaging device is by examining the images.

Unlike GPS facilities, the device is not capable of measuring the position. However, images that allow estimation of the one using the device or the location of the device can be captured, since the imaging device automatically and repeatedly images the scene surrounding the device and uploads the image thus captured to the management device. The position where the device is may be estimated by referring to the images. However, even if the one using the imaging device did not steal the device but came into possession of the device accidentally, images are still uploaded to the management device unnoticed by the one using the device. To address this, the imaging device configures upload images so that only the legitimate user of the device can view the images. In other words, even if the imaging device configures an image to be “published” in the normal status, the configuration is changed in a loss protection operation so that the publication of uploaded image is “restricted”. As a result, the one who came into possession of the device accidentally is protected.

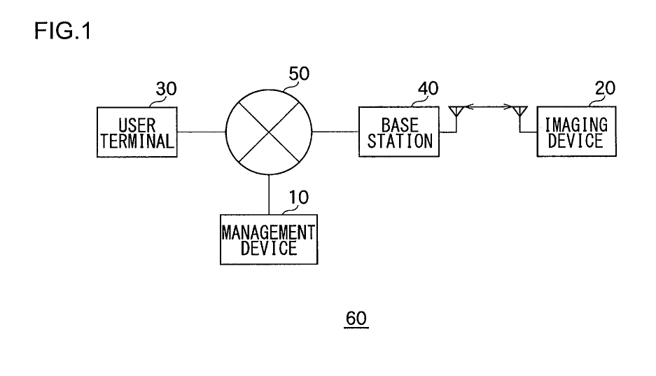

FIG. 1 shows the configuration of a management system 60 according to the embodiment. The management system 60 includes a management device 10, an imaging device 20, a user terminal 30, a base station 40, and a network 50. The imaging device 20 (e.g., a digital camera) is a device for capturing still images or moving images (hereinafter, generically referred to as “images”). Hereinafter, the term “image” is used to refer to both images captured and digital data for images without distinguishing them. The term “image” as used in this specification is synonymous with image data. The imaging device 20 is equipped with communication facilities. For example, the device 20 supports radio communication. Hereinafter, wireless local area network (LAN) will be described by way of example.

The imaging device 20 is connected to the network 50 via the base station 40 described below. The imaging device 20 uses the connection to upload captured images to the management device 10. The imaging device 20 also receives a control command from the management device 10. The imaging device 20 uploads an image to the management device 10 such that the device 20 uses either a “publish” mode, in which the uploaded image is made public to the management system 60 as a whole, or a “restricted” mode, in which the image is made available only to a specific user terminal 30. The imaging device 20 also connects to the management device 10 when the device 20 is started so as to communicate the device information of the device 20 (hereinafter, referred to as “ID” as mentioned above) to the device 10.

The base station 40 is connected by radio to the imaging device 20 at one end and connected by wire to the network 50 at the other end. It will be assumed here that the base station 40 is an access point (AP) of wireless LAN. The base station 40 serves as a relay allowing communication between the imaging device 20 and the network 50. For example, the network 50 is compatible with the Internet protocol (IP). The network 50 and the base station 40 may be configured using the related-art technology so that the description thereof is omitted.

The management device 10 is connected to the network 50 and communicates with the imaging device 20 and the user terminal 30 via the network 50. For example, the management device 10 is configured using a server. The management device 10 acquires an image from the imaging device 20 via the base station 40 and transmits the image thus acquired to the user terminal 30 in accordance with a request from the user terminal 30. The image thus acquired is configured to be “published” or “restricted”. Those images that are configured to be “restricted” are transmitted only in response to a request from a specific user terminal 30. The management device 10 transmits a control command to the imaging device 20.

The management device 10 performs a process of registering the imaging device 20 owned by the user (i.e., LOST registration) based on a request from the user terminal 30. In LOST registration, the ID of the imaging device 20 that the user has lost is stored. The management device 10 determines whether the ID communicated from the imaging device 20 is registered in LOST registration. When the device 10 acknowledges the ID from the imaging device 20 registered in LOST registration, the device 10 causes the imaging device 20 to perform a loss protection operation.

The user terminal 30 communicates with the management device 10 via the network 50. The user terminal 30 requests the management device 10 to transmit an image stored in the management device 10. The user terminal 30 displays the image acquired from the management device 10. When the publication of an image is configured to be “restricted”, the user terminal 30 transmits the identification information of the user terminal 30 to the management device 10. As a result, the management device 10 authenticates the user. The user ID may be used for authentication.

A summary of a loss protection operation will be given below. It will be assumed that the user loses the imaging device 20. Hereinafter, the term “loss” encompasses the act of theft. The user enters the ID of the lost imaging device 20 in the user terminal 30. The user terminal 30 requests the management device 10 to register the device 20 in LOST registration via the network 50. The management device 10 performs LOST registration for the ID thus acquired. Irrespective of whether the imaging device 20 is a lost device, the device 20 communicates the ID to the management device 10 by connecting to the management device 10 when the device 20 is started.

The management device 10 verifies whether the ID thus communicated is registered in LOST registration. The management device 10 directs, via the network 50, the imaging device 20 that has communicated the ID for which LOST registration is made to initiate a loss protection operation. Upon receipt of the direction, the imaging device 20 initiates a loss protection operation whereby the publication of an image as uploaded is configured to be “restricted”. Further, the imaging device 20 captures images periodically and automatically. Subsequently, the imaging device 20 uploads the image thus captured to the management device 10 via the network 50. The user terminal 30 receives the image from the management device 10 and displays the same. The user estimates the position where the imaging device 20 is by viewing the image.

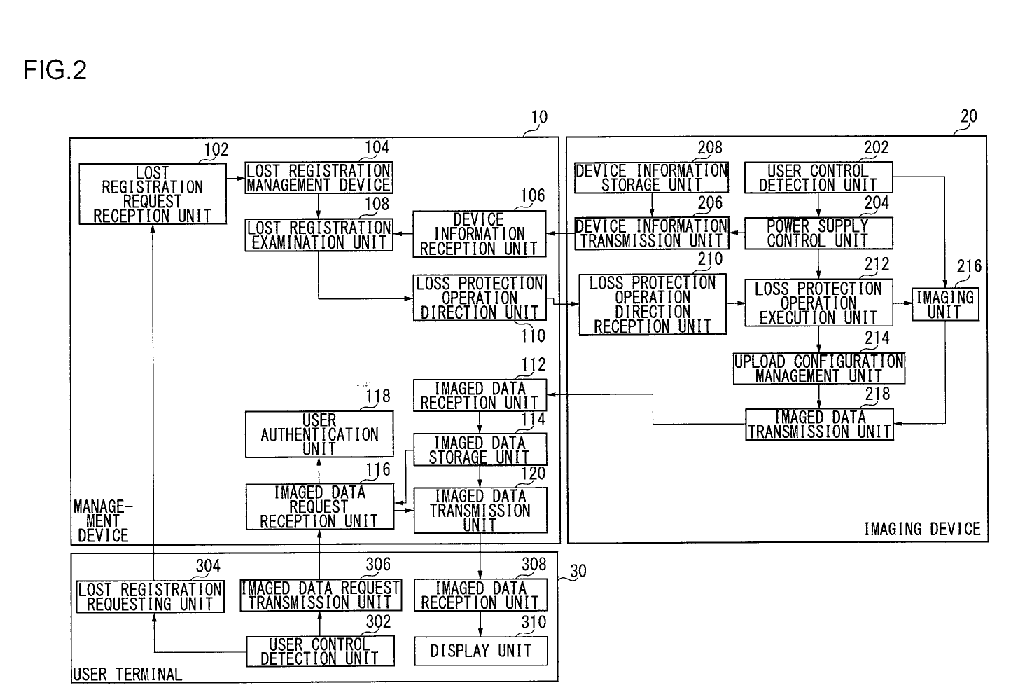

FIG. 2 shows the configuration of the management device 10, the imaging device 20, and the user terminal 30. The management device 10 includes a LOST registration request reception unit 102, a LOST registration management unit 104, a device information reception unit 106, a device information examination unit 108, a loss protection operation direction unit 110, an imaged data reception unit 112, an imaged data storage unit 114, an image data request reception unit 116, a user authentication unit 118, and an imaged data transmission unit 120. The imaging device 20 includes a user control detection unit 202, a power control unit 204, a device information transmission unit 206, a device information storage unit 208, a loss protection operation direction reception unit 210, a loss protection operation execution unit 212, an upload configuration management unit 214, an imaging unit 216, an imaged data transmission unit 218. The user terminal 30 includes a user control detection unit 302, a LOST registration requesting unit 304, an imaged data request transmission unit 306, an imaged data reception unit 308, and a display unit 310.

Unlike FIG. 1, the base station 40 and the network 50 are omitted from the illustration of FIG. 2. The LOST registration request reception unit 102 receives a notification (hereinafter, referred to as “LOST information”) from the user terminal 30 requesting LOST registration. The LOST information represents a direction to the imaging device 20 to capture images. The LOST information may include the ID, i.e., the identification information of the imaging device 20. The identification information may be a number assigned to the imaging device for identification or a MAC address.

The LOST registration request reception unit 102 requests the LOST registration management unit 104 to register the ID thus acquired in LOST registration by transmitting the ID to the LOST registration management unit 104. The LOST information may designate that the ID be no longer registered in LOST registration. In this process, the LOST registration request reception unit 102 verifies whether the source of the LOST information is the owner of the associated imaging device 20 and then requests the LOST registration management unit 104 to cancel the LOST registration.

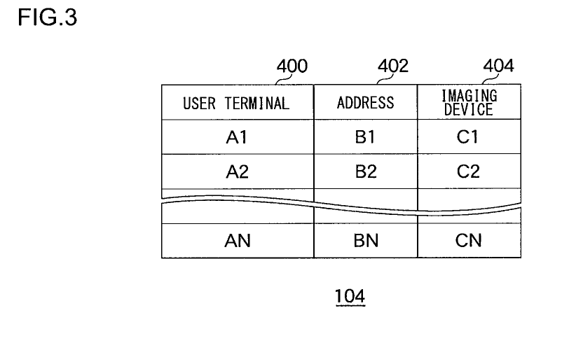

The LOST registration management unit 104 registers the ID in a LOST management table in accordance with a request from the LOST registration request reception unit 102. The LOST registration management unit 104 also deletes the ID in the LOST management table in accordance with a request from the LOST registration request reception unit 102. In this way, the LOST registration management unit 104 manages the LOST management table. The LOST registration management table is referred to by the device information examination unit 108 described later. FIG. 3 shows the data structure of the table stored in the LOST registration management unit 104. As illustrated, the data includes a user terminal column (fields) 400, an address column (fields) 402, and an imaging device column (fields) 404. The user terminal fields 400 store the identification information of the user terminal 30 that has requested the LOST registration. The user terminal fields 400 may store the user ID. The address fields 402 store the IP address of the associated user terminal 30. The imaging device fields 404 store the ID of the imaging device 20 monitored. Reference will be made to FIG. 2 again.

The device information reception unit 106 receives the ID communicated from the imaging device 20. The device information reception unit 106 receives the ID's from various imaging devices 20. The device information reception unit 106 outputs the ID to the device information examination unit 108. The device information examination unit 108 receives the ID from the device information reception unit 106. The device information examination unit 108 refers to the LOST management table managed by the LOST registration management unit 104 to determine whether the ID is registered in the LOST management table. When the ID is registered in the LOST management table, i.e., when the ID acknowledged by the LOST registration request reception unit 102 matches the ID acknowledged by the device information reception unit 106, the device information examination unit 108 notifies the loss protection operation direction unit 110 accordingly.

The loss protection operation direction unit 110 is notified by the device information examination unit 108 of the ID registered in the LOST management table. The loss protection operation direction unit 110 directs the imaging device 20 that has transmitted the ID to initiate a loss protection operation (hereinafter, such a direction will be referred to as “loss protection operation direction”). In other words, the loss protection operation direction unit 110 directs the imaging device 20, the ID of which is acknowledged by the device information reception unit 106, to capture images in accordance with a direction acknowledged by the LOST registration request reception unit and requesting images to be captured. The direction may designate that images be repeatedly captured.

The imaged data reception unit 112 receives an image from the imaging device 20. The image thus received includes information designating “published” or “restricted”, and a condition in which transmission is allowed in the case that “restricted” is designated. For example, the condition for transmission may designate the identification information of the user terminal 30. The condition for transmission may designate the user ID. The image received from the imaging device 20 directed to initiate a loss protection operation is configured to be “restricted”. Since the imaging device 20 captures images repeatedly, the imaged data reception unit 112 receives captured images repeatedly. The imaged data reception unit 112 stores the image in the imaged data storage unit 114 along with the information attached to the image.

The imaged data storage unit 114 stores the image and the information attached to the image in accordance with a direction from the imaged data reception unit 112. The image stored in the imaged data storage unit 114 is referred to by the imaged data transmission unit 120. The imaged data request reception unit 116 receives a request to transmit an image from the user terminal 30. When the imaged data request reception unit 116 determines that the image is configured to be “restricted” by referring to the imaged data storage unit 114, the unit 116 requests the user authentication unit 118 to determine whether the condition for transmission is met. When the user authentication unit 118 determines that the condition for transmission is met, or when the imaged data as requested is configured to be “published”, the imaged data request reception unit 116 requests the imaged data transmission unit 120 to transmit the requested image.

The user authentication unit 118 determines whether the user terminal 30 requesting the transmission of the image meets the condition for transmission, in accordance with the request from the imaged data request reception unit 116. More specifically, the user authentication unit 118 extracts the condition for transmission (e.g., the identification information of the user terminal 30) associated with the target image, by referring to the imaged data storage unit 114. The information thus extracted represents the identification information of the user terminal 30 that has requested LOST registration. Alternatively, the user ID may be extracted as the condition for transmission. When the identification information thus extracted matches the identification information included in the request for transmission, the unit 118 determines that the condition for transmission is met and outputs the result to the imaged data request reception unit 116. In response to the request from the imaged data request reception unit 116, the imaged data transmission unit 120 transmits the image stored in the imaged data storage unit 114 to the user terminal 30.

The user control detection unit 202 comprises buttons etc. and detects the user control. The user control represents directions such as turn-on, turn-off, and imaging. When the user control detected relates to the power supply, the unit 202 notifies the power control unit 204 accordingly. The user control related to the power supply represents turn-on and turn-off. The power control unit 240 receives the detail of the user control related to the power supply from the user control detection unit 202 and turns on or off the power supply in accordance with the detail detected. Further, the power control unit 204 requests the device information transmission unit 206 to transmit the ID when the device 20 is turned on.

The device information transmission unit 206 transmits the ID stored in the device information storage unit 208 to the management device 10 in accordance with a request from the power supply control unit 204. In other words, the device information transmission unit 206 transmits the ID to the management device 10 when the device 20 is started. The device information storage unit 208 stores the ID of the imaging device 20. The unit 208 also stores transmission permission information related to a condition in which transmission is allowed in the case that the image as uploaded is “restricted”. The ID is referred to by the device information transmission unit 206 and the transmission permission information is referred to by the imaged data transmission unit 218.

The loss protection operation direction reception unit 210 receives a direction for loss protection operation from the management device 10. The loss protection operation direction reception unit 210 requests the loss protection operation execution unit 212 to initiate a loss protection operation. In other words, the loss protection operation direction reception unit 210 receives a direction to capture images from the management device 10 to which the device information transmission unit 206 has transmitted the ID. As mentioned before, the direction for loss protection operation is generated when it is determined in the management device 10 that the ID of the imaging device 20 requested to capture an image matches the ID transmitted by the device information transmission unit 206. The direction for loss protection operation designates that images are repeatedly captured.

The loss protection operation execution unit 212 executes a loss protection operation in accordance with a request from the loss protection operation direction reception unit 210. A loss protection operation is defined as follows. The image as uploaded is forced to be “restricted”. Meanwhile, in the normal operation, the image as uploaded may be configured to be “published” or “restricted” by selection. In a loss protection operation, images are captured periodically so that the images captured are uploaded to the management device 10. Further, the detail of user control as detected by the user control detection unit 202, i.e., the user control acknowledged from the user in control, may be invalidated. The loss protection operation execution unit 212 directs the upload configuration management unit 214 and the imaging unit 216 to execute the above operation.

The imaging unit 216 captures images. In the normal operation, the imaging unit 216 captures an image when the unit 216 acknowledges from the user control detection unit 202 the user control for capturing an image. Meanwhile, when the imaging unit 216 acknowledges a request from the loss protection operation execution unit 212, i.e., while in a loss protection operation, the unit 216 automatically captures images in accordance with a direction for loss protection operation irrespective of whether there is any direction from the user control detection unit 202. Images are captured repeatedly. The imaging unit 216 outputs the image thus captured to the imaged data transmission unit 218.

The upload configuration management unit 214 manages “published” or “restricted” configurations for upload. As mentioned before, the upload configuration management unit 214 configures an image to be “published” or “restricted” in the normal operation. The unit 214 configures an image to be “restricted” without exception when the unit 214 acknowledges a request from the loss protection operation execution unit 212. When an image is configured to be “restricted”, the ultimate destination of output of the image is restricted to the source of the request to capture images, i.e., the user terminal 30 requesting the LOST registration. When the user ID is used, the destination may be restricted to the user terminal 30 logging in using the user ID. The configuration for upload managed by the upload configuration management unit 214 is referred to when the imaged data transmission unit 218 transmits the image.

The imaged data transmission unit 218 receives the image from the imaging unit 216 and transmits the input image to the management device 10. In this process, the imaged data transmission unit 218 refers to the upload configuration managed by the upload configuration management unit 214. When the image is configured to be “published”, the imaged data transmission unit 218 transmits the image, configuring the image as uploaded to be “published”. Conversely, when the image is configured to be “restricted”, the imaged data transmission unit 218 appends transmission permission information maintained by the device information storage unit 208 to the image before transmitting the image to the management device 10. In a loss protection operation, the image data transmission unit 218 transmits images repeatedly.

The user control detection unit 302 detects the user control. For example, when the owner of the imaging device 20 has lost the imaging device 20, the user control detection unit 302 detects the user control related to LOST registration. When the user control detection unit 302 detects the user control related to LOST registration, the unit 302 outputs the detail to the LOST registration requesting unit 304. When the unit 302 detects the user control requesting transmission of an image, the unit 302 transmits the detail to the imaged data request transmission unit 306.

When the LOST registration requesting unit 304 acknowledges the user control related to LOST registration from the user control detection unit 302, the unit 304 transmits a request for LOST registration to the management device 10. The request for LOST registration includes the ID of the target imaging device 20 and user information such as the user ID and the password. The term “request for LOST registration” encompasses a request for removal from LOST registration. When the imaged data request transmission unit 306 acknowledges a request for transmission of an image from the user control detection unit 302, the unit 306 requests the management device 10 to transmit the image. The imaged data reception unit 308 receives the image transmitted from the management device 10 in response to the request transmitted by the imaged data request transmission unit 306. The imaged data reception unit 308 outputs the image to the display unit 310. The display unit 310 displays the image received by the imaged data reception unit 308.

The configuration is implemented, in hardware, by any CPU of a computer, a memory, or other LSIs and, in software, by a program or the like loaded into the memory. FIG. 2 depicts functional blocks implemented by the cooperation of hardware and software. Therefore, it will be obvious to those skilled in the art that the functional blocks may be implemented in a variety of manners by hardware only, software only, or a combination of thereof.

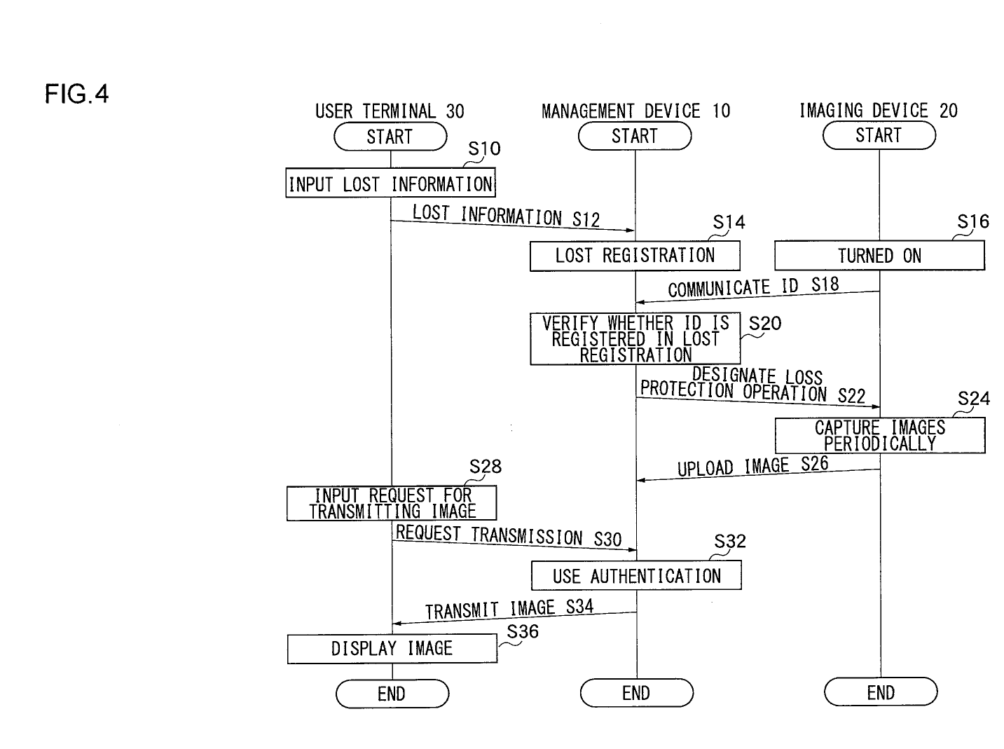

A description will be given of a summary of the operation of the management system 60 configured as described above. FIG. 4 is a sequence chart showing the process performed by the management system 60 in the event of a loss of the device. The user terminal 30 acknowledges an input of LOST information (S10). The user terminal 30 transmits the LOST information to the management device 10 (S12). The management device 10 performs LOST registration based on the LOST information (S14). The imaging device 20 is started by the finder (S16). The imaging device 20 communicates the ID to the management device 10 (S18). The management device 10 verifies whether the ID is registered in LOST registration (S20).

The management device 10 directs the imaging device 20 to initiate a loss protection operation (S22). The imaging device 20 captures images periodically (S24). The imaging device 20 uploads the images (S26). The user terminal 30 acknowledges an input requesting transmission of an image (S28). The user terminal 30 transmits a request for transmission to the management device 10 (S30). The management device 10 performs user authentication (S32) and transmits the image to the user terminal 30 (S34). The user terminal 30 displays the image (S36).

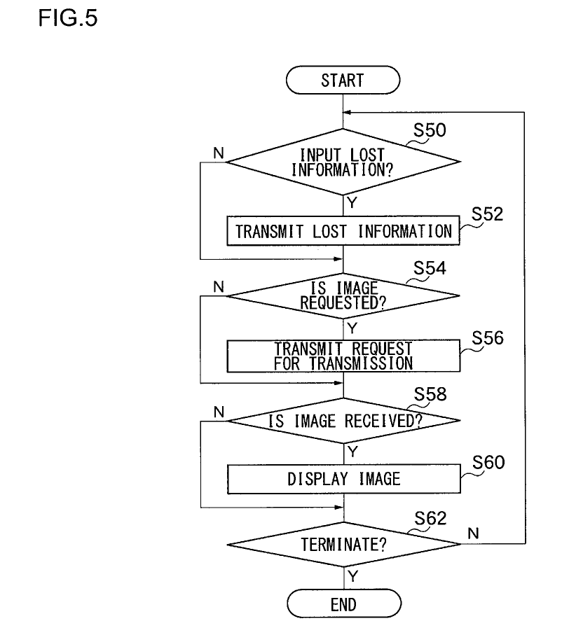

FIG. 5 is a flowchart showing the process performed by the user terminal 30 in the event of a loss of the device. When the user control detection unit 302 acknowledges an input of LOST information (Y in S50), the LOST registration requesting unit 304 transmits the LOST information to the management device 10 (S52). Conversely, when the user control detection unit 302 does not acknowledge an input of LOST information (N in S50), step 52 is skipped. When the user control detection unit 302 acknowledges a request for transmission of an image (Y in S54), the imaged data request transmission unit 306 transmits a request for transmission to the management device 10 (S56). Conversely, when the user control detection unit 302 does not acknowledge a request for transmission of an image (N in S54), step 56 is skipped. When the imaged data reception unit 308 receives an image from the management device 10 (Y in S58), the display unit 310 displays the image (S60). Conversely, when the imaged data reception unit 308 does not receive an image from the management device 10 (N in S56), step 60 is skipped. When the process is not to be terminated (N in S62), control is returned to step 50. When the process is to be terminated (Y in S62), the process is terminated.

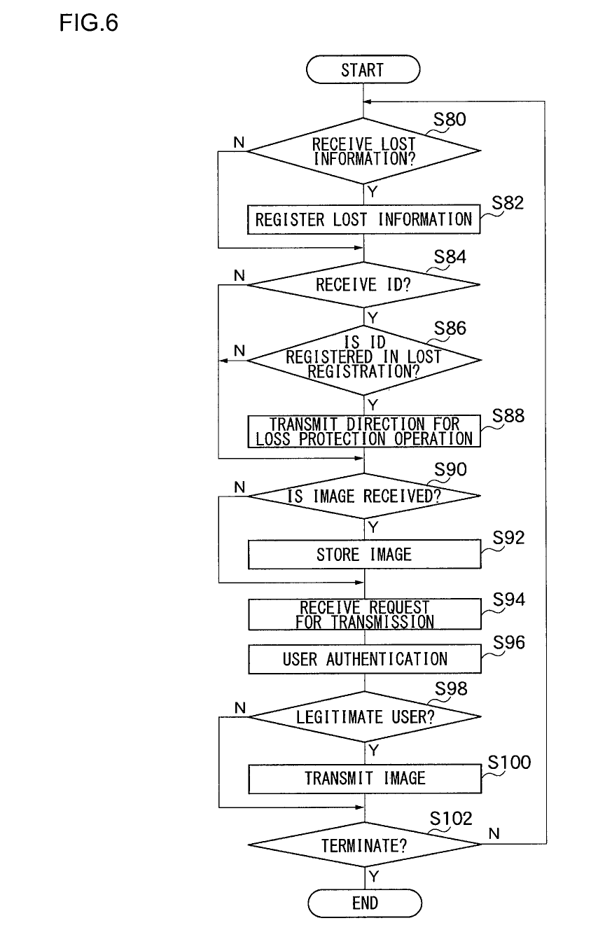

FIG. 6 is a flowchart showing the process performed by the management device 10 in the event of a loss of the device. When the LOST registration request reception unit 102 receives LOST information from the user terminal 30 (Y in S80), the LOST registration management unit 104 registers the LOST information (S82). Conversely, when the LOST registration request reception unit 102 does not receive LOST information from the user terminal 30 (N in S80), step 82 is skipped. When the device information reception unit 106 receives the ID from the imaging device 20 (Y in S84) and when the ID is registered in LOST registration (Y in S86), the loss protection operation direction unit 110 transmits a direction for loss protection operation (S88). Conversely, when the device information reception unit 106 does not receive the ID from the imaging device 20 (N in S84), or when the ID is not registered in LOST registration (N in S86), step 88 is skipped. When the imaged data reception unit 112 receives an image from the imaging device 20 (Y in S90), the imaged data storage unit 114 stores the image (S92).

When the imaged data reception unit 112 does not receive the image from the imaging device (N in S90), step 92 is skipped. The imaged data request reception unit 116 receives a request for transmission from the user terminal 30 (S94). The user authentication unit 118 performs user authentication to determine whether the source of the request for transmission is a legitimate user (S96). When the request is from a legitimate user (Y in S98), the imaged data transmission unit 120 transmits the image to the user terminal 30 (S100). Conversely, when the request is not from a legitimate user (N in S98), step 100 is skipped. When the process is not to be terminated (N in S102), control is returned to step 80. When the process is to be terminated (Y in S102), the process is terminated.

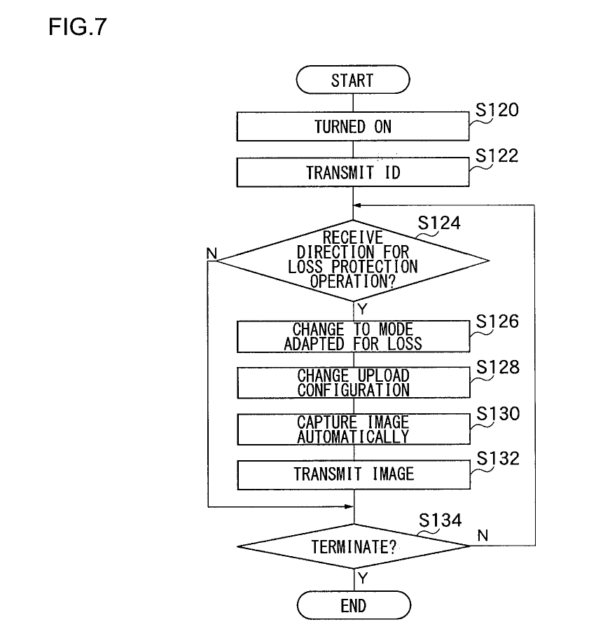

FIG. 7 is a flowchart showing the process performed by the imaging device 20 in the event of a loss of the device. When the power supply control unit 204 detects that the device is turned on (S120), the device information transmission unit 206 transmits the ID to the management device 10 (S122). When the loss protection direction reception unit 210 receives a direction for loss protection direction (Y in S124), the loss protection operation execution unit 212 changes the operation to a mode adapted for a loss of the device (S126). The upload configuration management unit 214 changes the configuration for upload (S128). The imaging unit 216 captures an image automatically (S130). The imaged data transmission unit 218 transmits the image to the management device 10 (S132). When the loss protection direction reception unit 210 does not receive a direction for loss protection operation (N in S124), steps 126 through 132 are skipped. When the process is not to be terminated (N in S134), control is returned to step 124. When the process is to be terminated (Y in S134), the process is terminated.

A description will now be given of the first variation to the embodiment. Like the embodiment described above, the first variation relates to a management system 60 in which the imaging device 20 is lost is allowed to capture an image, and the management device 10 transmits the image to the user terminal 30. The imaging device 20 according to the embodiment described above configures images as uploaded to be “restricted” in a loss protection operation. The imaging device 20 according to the first variation configures images to be “published”. In other words, images can be viewed not only by the user owning the imaging device 20 but also by others. As a result, the images are made public unnoticed by the owner even if the one using the imaging device 20 came into possession of the device accidentally. The first variation is directed to reducing the disadvantages suffered by the one who came into possession of the device accidentally in such situations.

The imaging device 20 identifies those portions of the captured image that are linked to the identity of the owner and pixelizes the portions thus identified. The imaging device 20 uploads the image thus pixelized in the “publish” mode. The management device 10 publishes the pixelized image. The rule used for pixelization (e.g., the key to depixelize the image) is known to the owner of the imaging device 20. This allows the user terminal 30 controlled by the owner to recover the depixelized image and displays the original image accordingly. Meanwhile, the user terminal 30 controlled by the stranger displays the pixelized image. The configuration of the management system 60 according to the first variation is of the same type as that of FIG. 1 or FIG. 2.

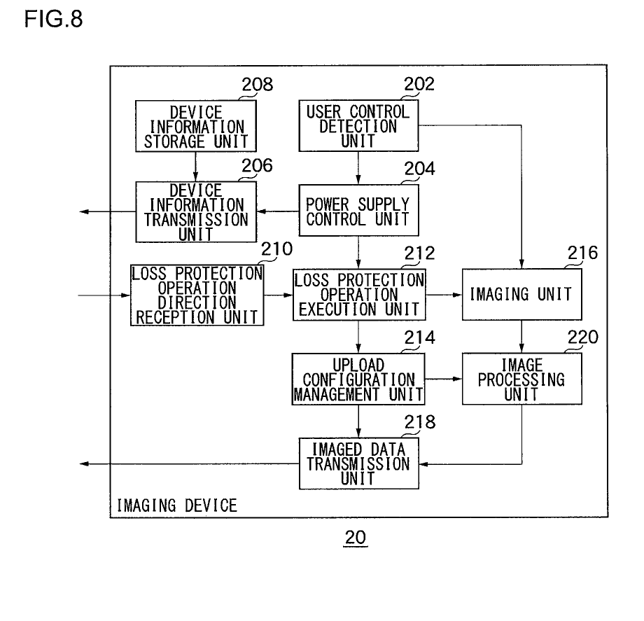

FIG. 8 shows the configuration of the imaging device 20 according to the first variation. In addition to the components of the imaging device 20 of FIG. 2, the device 20 of FIG. 8 further includes an image processing unit 220. As in the embodiment, the loss protection operation direction reception unit 210 receives a loss protection operation direction from the management device 10. The loss protection operation execution unit 212 executes a loss protection operation in accordance with a request from the loss protection operation reception unit 210. The loss protection operation according to the first variation is different from that of the embodiment. The image as uploaded is forced to be “published”. Instead, the image is pixelized. In the normal operation, the image as uploaded may be configured to be “published” or “restricted” by selection. Images are captured periodically so that the images captured are uploaded to the management device 10. The loss protection operation execution unit 212 directs the upload configuration management unit 214 and the imaging unit 216 to execute the above operation. The imaging unit 216 captures images as in the embodiment.

The upload configuration management unit 214 configures an image as uploaded to be “published” or “restricted”. The upload configuration management unit 214 configures an image to be “published” or “restricted” in the normal operation. The unit 214 configures an image to be “published” without exception when the unit 214 acknowledges a request from the loss protection operation execution unit 212. In a loss protection operation, the upload configuration management unit 214 directs the image processing unit 220 to perform pixelization.

The image processing unit 220 is directed by the upload configuration management unit 214 to perform pixelization in a loss protection operation. The image processing unit 220 pixelizes at least a part of the image in accordance with the direction. For example, the image processing unit 220 identifies a face portion in the image and pixelizes the face portion thus identified. For identification of a face part or pixelization, the publicly known technology may be used. For example, “reversible pixelization” or “masking” may be employed.

The device information storage unit 208 stores a password for use in pixelization. The image processing unit 220 performs pixelization in accordance with the password stored in the device information storage unit 208. The password is known only to the one requesting capturing of images, i.e., the owner of the imaging device 20. As a result, the user terminal 30 used by the owner of the imaging device 20 can recover the original image using the password. Meanwhile, other user terminals 30 display the image where the face portion is pixelized. In the normal operation, the image processing unit 220 does not perform pixelization. The imaged data transmission unit 218 receives the image from the image processing unit 220 and transmits the input image to the management device 10.

The imaged data request reception unit 116 in the management device (not shown) receives a request to transmit an image from the user terminal 30. When the imaged data as requested is configured to be “published”, the imaged data request reception unit 116 requests the imaged data transmission unit 120 to transmit the requested image. In response to the request from the imaged data request reception unit 116, the imaged data transmission unit 120 transmits the image stored in the imaged data storage unit 114, i.e., the pixelized image, to the user terminal 30.

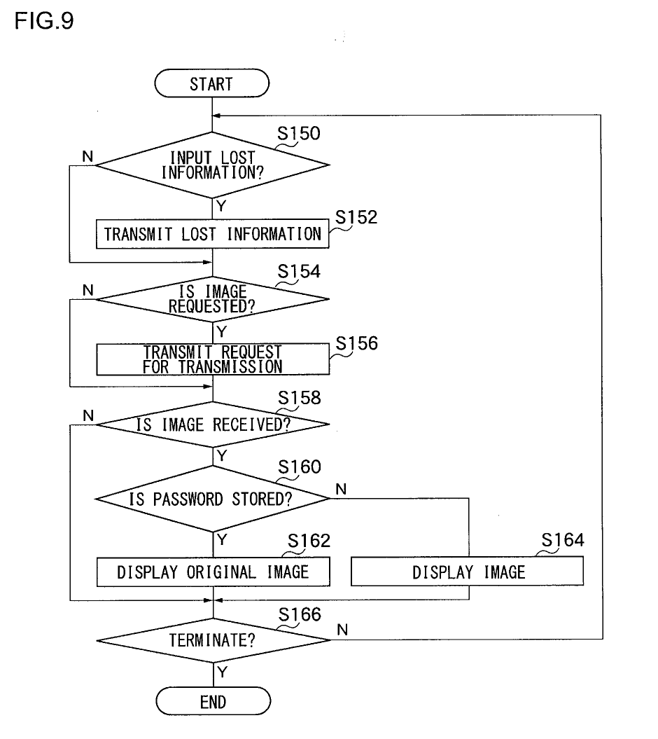

FIG. 9 is a flowchart showing the process performed by the user terminal 30 according to the first variation in the event of a loss of the device. Steps 150 through 156 are the same as steps 50 through 56 in FIG. 5 so that the description thereof is omitted. When the imaged data reception unit 308 receives an image from the management device 10 (Y in 5158) and the password is stored (Y in S160), the display unit 310 displays the original image (S162). When the password is not stored (N in S160), the display unit 310 display the pixelized image (S164). Conversely, when the imaged data reception unit 308 does not receive an image from the management device 10 (N in S158), steps 160 through 164 are skipped. When the process is not to be terminated (N in S166), control is returned to step 150. When the process is to be terminated (Y in S166), the process is terminated.

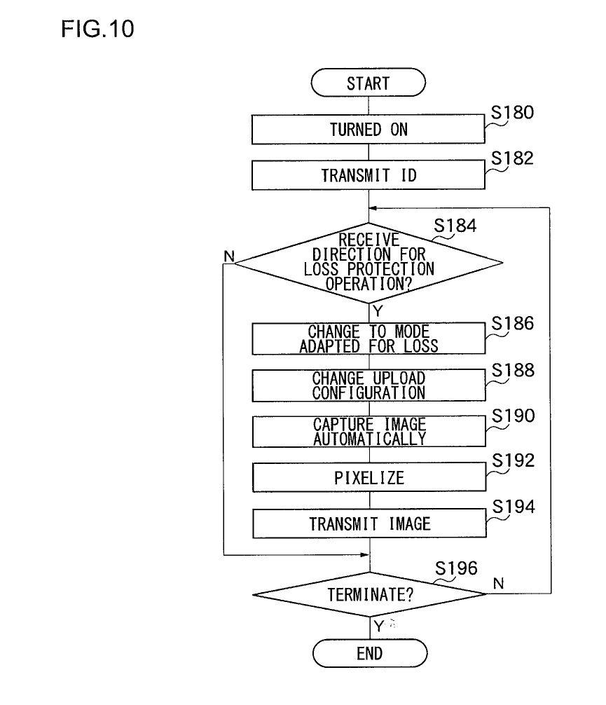

FIG. 10 is a flowchart showing the process performed by the imaging device 20 in the event of a loss of the device. Steps 180 through 190 are the same as steps 120 through 130 in FIG. 7 so that the description thereof is omitted. The image processing unit 220 performs pixelization (S192) and the imaged data transmission unit 218 transmits the image to the management device 10 (S194). When the loss protection direction reception unit 210 does not receive a direction for loss protection operation (N in S184), steps 186 through 194 are skipped. When the process is not to be terminated (N in S196), control is returned to step 184. When the process is to be terminated (Y in S196), the process is terminated.

A description will be given of the second variation. As in the first variation, the management device 10 according to the second variation publishes a pixelized image and the user terminal 30 controlled by the owner of the imaging device 20 recovers the depixelized image and displays the original image. While pixelization according to the first variation is performed by the imaging device 20, pixelization according to the second variation is performed by the management device 10. The configuration of the management system 60 according to the second variation is of the same type as that of FIG. 1 or FIG. 2. In a loss recovery operation, the imaging device 20 according to the second variation configures an image as uploaded to be “published” and transmits the image accordingly.

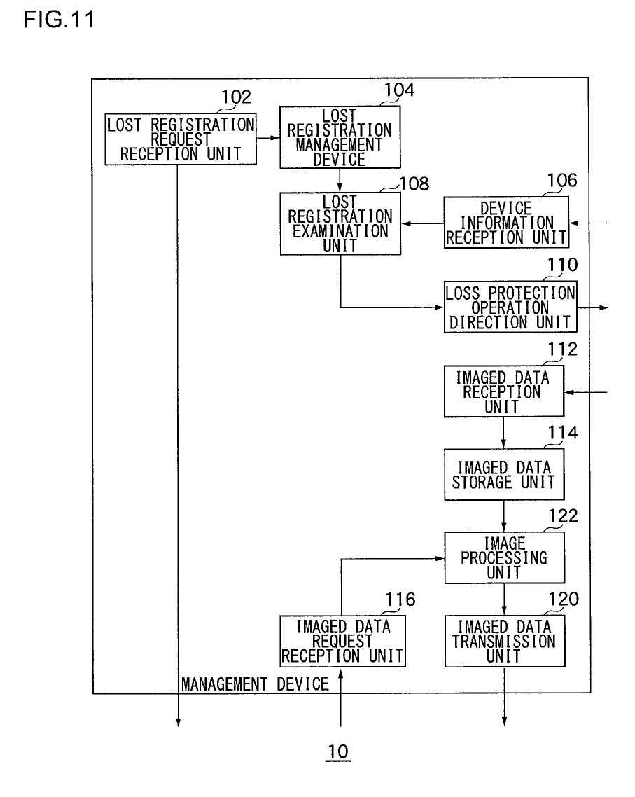

FIG. 11 shows the configuration of the management device 10 according to the second variation. The management device 10 differs from the management device 10 of FIG. 2 in that it does not include the user authentication unit 118 and further includes an image processing unit 122. The imaged data reception unit 112 receives an image from the imaging device 20. Even the image received from the imaging device 20 directed to perform a loss protection operation is configured to be “published”. The imaged data reception unit 116 receives a request to transmit an image from the user terminal 30.

Upon a request from the imaged data request reception unit 116, the image processing unit 122 pixelizes at least a part of the image stored in the imaged data storage unit 114. Pixelization may be performed as in the image processing unit 220 of FIG. 8 so that the description thereof is omitted. The password used for pixelization may be acknowledged by the LOST registration request reception unit 102 along with LOST information and stored by the LOST registration management unit 104 so as to be included in the table. The image processing unit 122 refers to the table stored in the LOST registration management unit 104 to pixelize an image. The password is known only to the one requesting capturing of images, i.e., the owner of the imaging device 20. The imaged data transmission unit 120 outputs the image pixelized in the image processing unit 122.

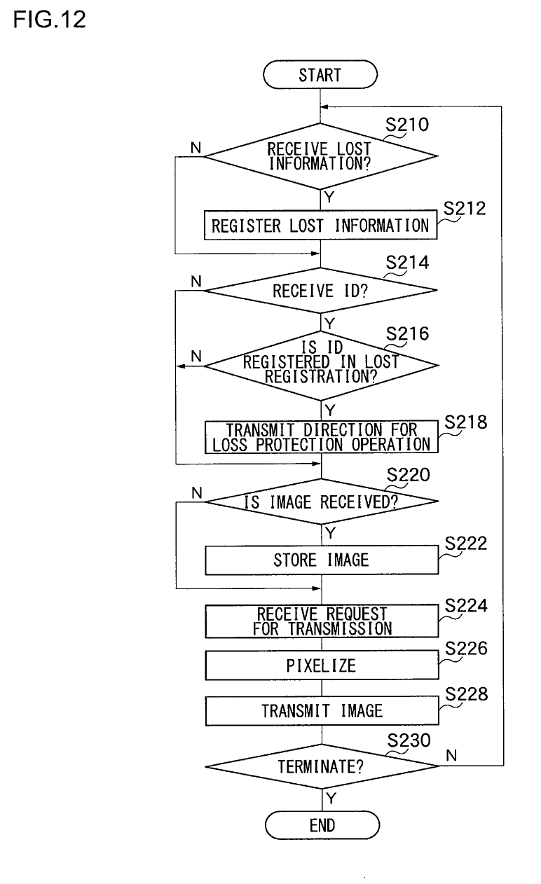

FIG. 12 is a flowchart showing the process performed by the management device 10 in the event of a loss of the device. Steps 210 through 224 are the same as steps 80 through 94 in FIG. 6 so that the description thereof is omitted. The image processing unit 122 performs pixelization (S226) and the imaged data transmission unit 120 transmits the image to the user terminal 30 (S228). When the process is not to be terminated (N in S230), control is returned to step 210. When the process is to be terminated (Y in S230), the process is terminated.

The third variation of the present invention relates to a management system in which a user terminal, a management device, and an imaging device communicate via a network. The imaging device (e.g. a camera) stores a captured image in a memory card. When the imaging device is lost or stolen, the user generally wants to recover the image in the memory and does not want the image in the memory to be viewed by others. In order to address this, the management system according to the present invention performs the following process. When the imaging device is lost, the user transmits the fact that the device is lost (hereinafter, referred to as “LOST information”) to the management device by controlling the terminal. The LOST information includes identification information identifying the imaging device (hereinafter, referred to as “ID”).

The management device registers the imaging device as a target of monitoring by receiving the LOST information (hereinafter, referred to as “LOST registration”). The imaging device transmits the ID to the management device via the network when the device is started. Upon receipt of the ID, the management device verifies whether the ID is registered in LOST registration. When the LOST registration is made, the management device directs the imaging device to perform an operation to counter the event of loss (hereinafter, referred to as loss protection operation). The imaging device receiving the direction transmits the image already captured and stored to the management device. When the image is received from the imaging device, the management device stores the image. When the transmission of the image is completed, the imaging device deletes the image stored.

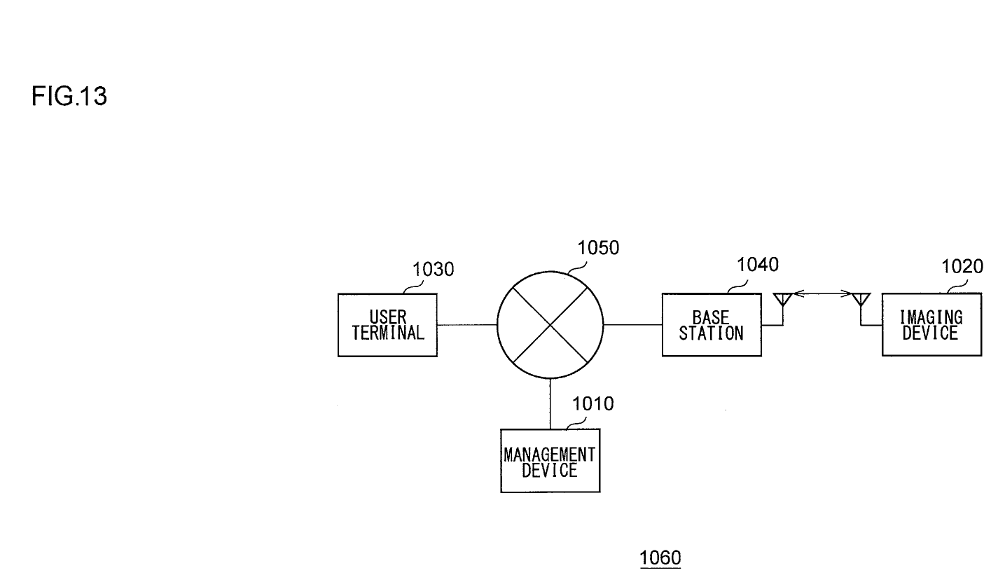

FIG. 13 shows the configuration of a management system 1060 according to the third variation. The management system 1060 includes a management device 1010, an imaging device 1020, a user terminal 1030, a base station 1040, and a network 1050. The imaging device 1020 (e.g., a digital camera) is a device for capturing still images or moving images (hereinafter, generically referred to as “images”). Hereinafter, the term “image” is used to refer to both images captured and digital data for images without distinguishing them. The term “image” as used in this specification is synonymous with image data. The imaging device 1020 is equipped with communication facilities. For example, the device supports radio communication. Hereinafter, wireless local area network (LAN) will be described by way of example.

The imaging device 1020 is connected to the network 1050 via the base station 1040 described below. The imaging device 1020 uses the connection to upload captured images to the management device 1010. The imaging device 1020 also receives a control command from the management device 1010. The imaging device 1020 uploads an image to the management device 1010 such that the device 1020 uses either a “publish” mode, in which the uploaded image is made public to the management system 1060 as a whole, or a “restricted” mode, in which the image is made available only to a specific user terminal 1030. The imaging device 1020 also connects to the management device 1010 when the device 1020 is started so as to communicate the device information of the device 1020 (hereinafter, referred to as “ID” as mentioned above) to the device 1010.

The base station 1040 is connected by radio to the imaging device 1020 at one end and connected by wire to the network 1050 at the other end. It will be assumed here that the base station 1040 is an access point (AP) of wireless LAN. The base station 1040 serves as a relay allowing communication between the imaging device 1020 and the network 1050. For example, the network 1050 is compatible with the Internet protocol (IP). The network 1050 and the base station 1040 may be configured using the related-art technology so that the description thereof is omitted.

The management device 1010 is connected to the network 1050 and communicates with the imaging device 1020 and the user terminal 1030 via the network 1050. For example, the management device 1010 is configured using a server. The management device 1010 acquires an image from the imaging device 1020 via the base station 1040 and transmits the image thus acquired to the user terminal 1030 in accordance with a request from the user terminal 1030. The image acquired is configured to be “published” or “restricted”. Those images that are configured to be “restricted” are transmitted only in response to a request from a specific user terminal 1030. The management device 1010 transmits a control command to the imaging device 1020.

The management device 1010 performs a process of registering the imaging device 1020 owned by the user (i.e., LOST registration) based on a request from the user terminal 1030. In LOST registration, the ID of the imaging device 1020 that the user has lost is stored. The management device 1010 determines whether the ID communicated from the imaging device 1020 is registered in LOST registration. When the device 1010 acknowledges the ID from the imaging device 1020 registered in LOST registration, the device 1020 causes the imaging device 1020 to perform a loss protection operation.

The user terminal 1030 communicates with the management device 1010 via the network 1050. The user terminal 1030 requests the management device 1010 to transmit an image stored in the management device 1010. The user terminal 1030 displays the image acquired from the management device 1010. When the publication of an image is configured to be “restricted”, the user terminal 1030 transmits the identification information of the user terminal 1030 to the management device 1010. As a result, the management device 1010 authenticates the user. The user ID may be used for authentication. The user losing the imaging device 1020 requests the management device 1010 to register the device 1020 in LOST registration, by controlling the user terminal 1030.

A summary of a loss protection operation will be given below. It will be assumed that the user loses the imaging device 1020. Hereinafter, the term “loss” encompasses the act of theft. The user enters the ID of the lost imaging device 1020 in the user terminal 1030. The user terminal 1030 requests the management device 1010 to register the device 1020 in LOST registration via the network 1050. The management device 1010 performs LOST registration for the ID thus acquired. Irrespective of whether the imaging device 1020 is a lost device, the device 1020 communicates the ID to the management device 1010 by connecting to the management device 1010 when the device 1020 is started.

The management device 1010 verifies whether the ID thus communicated is registered in LOST registration. The management device 1010 directs, via the network 1050, the imaging device 1020 that has communicated the ID for which LOST registration is made to initiate a loss protection operation. Upon receipt of the direction, the imaging device 1020 initiates a loss protection operation whereby the publication of an image as uploaded is configured to be “restricted”. Further, the imaging device 1020 uploads the stored image to the management device 1010 via the network 1050. When the upload is completed, the imaging device 1020 deletes the stored image. The management device 1010 stores the image acknowledged from the imaging device 1020.

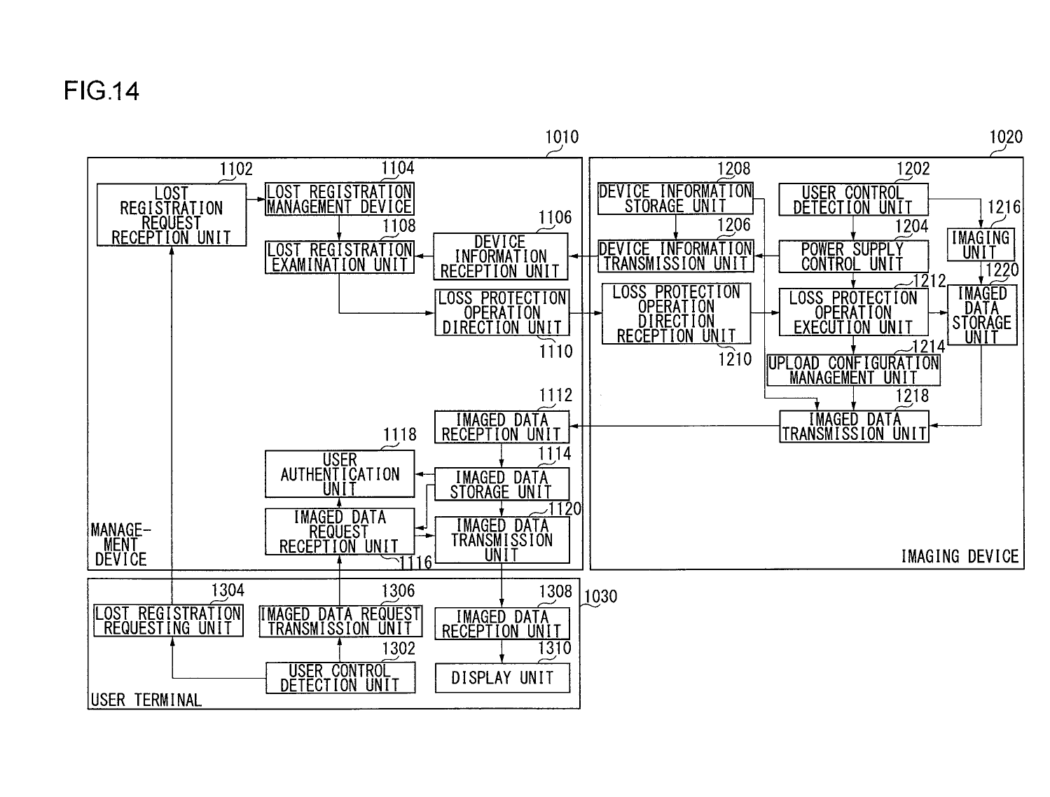

FIG. 14 shows the configuration of the management device 1010, the imaging device 1020, and the user terminal 1030. The management device 1010 includes a LOST registration request reception unit 1102, a LOST registration management unit 1104, a device information reception unit 1106, a device information examination unit 1108, a loss protection operation direction unit 1110, an imaged data reception unit 1112, an imaged data storage unit 1114, an image data request reception unit 1116, a user authentication unit 1118, and an imaged data transmission unit 1120. The imaging device 1020 includes a user control detection unit 1202, a power control unit 1204, a device information transmission unit 1206, a device information storage unit 1208, a loss protection operation direction reception unit 1210, a loss protection operation execution unit 1212, an upload configuration management unit 1214, an imaging unit 1216, an imaged data transmission unit 1218. The user terminal 1030 includes a user control detection unit 1302, a LOST registration requesting unit 1304, an imaged data request transmission unit 1306, an imaged data reception unit 1308, and a display unit 1310.

Unlike FIG. 13, the base station 1040 and the network 1050 are omitted from the illustration of FIG. 14. The LOST registration request reception unit 1102 receives a notification (hereinafter, referred to as “LOST information”) from the user terminal 1030 requesting LOST registration. The LOST information may include the ID, i.e., the identification information of the imaging device 1020. The LOST information can be said to represent a direction requesting the imaging device 1020 to delete a stored image after transmitting the image. The ID can be said to represent the identification information of the imaging device 1020 equipped with communication facilities and subject to monitoring. The LOST registration request reception unit 1102 requests the LOST registration management unit 1104 to register the ID thus acquired in LOST registration by transmitting the ID to the LOST registration management unit 1104. The LOST information may designate that the ID be no longer registered in LOST registration. In this process, the LOST registration request reception unit 1102 verifies whether the source of the LOST information is the owner of the associated imaging device 1020 and then requests the LOST registration management unit 1104 to cancel the LOST registration.

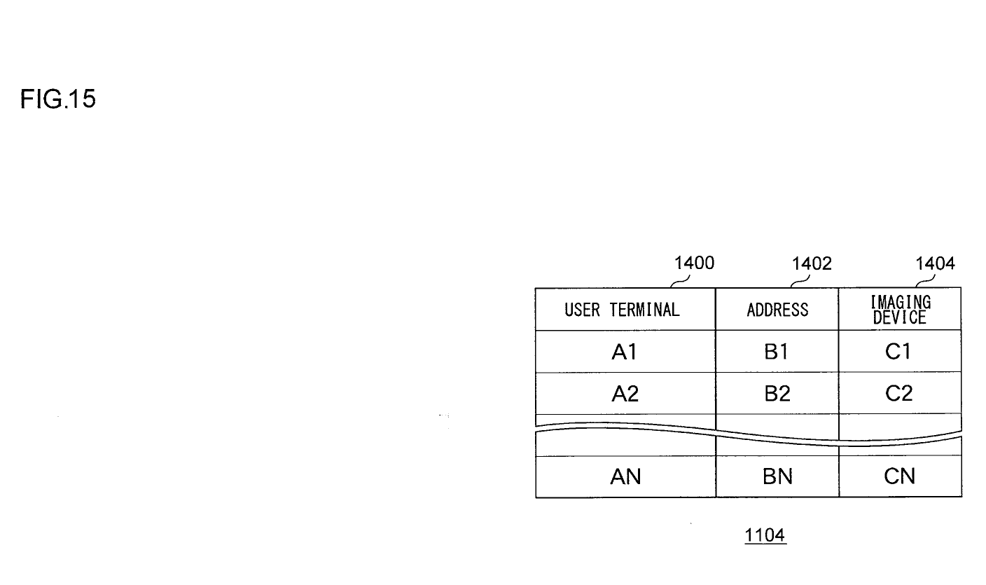

The LOST registration management unit 1104 registers the ID in a LOST management table in accordance with a request from the LOST registration request reception unit 1102. The LOST registration management unit 1104 also deletes the ID in the LOST management table in accordance with a request from the LOST registration request reception unit 1102. In this way, the LOST registration management unit 1104 manages the LOST management table. The LOST registration management table is referred to by the device information examination unit 1108 described later. FIG. 15 shows the data structure of the table stored in the LOST registration management unit 1104. As illustrated, the data includes a user terminal column (fields) 1400, an address column (fields) 1402, and an imaging device column (fields) 1404. The user terminal fields 1400 store the identification information of the user terminal 1030 that has requested the LOST registration. The user terminal fields 1400 may store the user ID. The address fields 1402 store the IP address of the associated user terminal 1030. The imaging device fields 1404 store the ID of the imaging device 1020 monitored. Reference will be made to FIG. 14 again.

The device information reception unit 1106 receives the ID communicated from the imaging device 1020. The ID represents the identification information of the imaging device 1020. The device information reception unit 1106 receives the ID's from various imaging devices 1020. The device information reception unit 1106 outputs the ID to the device information examination unit 1108. The device information examination unit 1108 receives the ID from the device information reception unit 1106. The device information examination unit 1108 refers to the LOST management table managed by the LOST registration management unit 1104 to determine whether the ID is registered in the LOST management table. When the ID is registered in the LOST management table, i.e., when the ID acknowledged by the LOST registration request reception unit 1102 matches the ID acknowledged by the device information reception unit 1106, the device information examination unit 1108 notifies the loss protection operation direction unit 1110 accordingly.

The loss protection operation direction unit 1110 is notified by the device information examination unit 1108 of the ID registered in the LOST management table. The loss protection operation direction unit 1110 directs the imaging device 1020 that has transmitted the ID to initiate a loss protection operation (hereinafter, such a direction will be referred to as “loss protection operation direction”). In other words, the loss protection operation direction unit 1110 directs the imaging device 1020, the ID of which is acknowledged by the device information reception unit 1106, to delete a stored image after transmitting the image.

The imaged data reception unit 1112 receives an image from the imaging device 1020. The image thus received includes information designating “published” or “restricted”, and a condition in which transmission is allowed in the case that “restricted” is designated. For example, the condition for transmission may designate the identification information of the user terminal 1030. The condition for transmission may designate the user ID. The image received from the imaging device 1020 directed to initiate a loss protection operation is configured to be “restricted”. The imaged data reception unit 1112 stores the image in the imaged data storage unit 1114 along with the information attached to the image. The imaged data storage unit 1114 stores the image and the information attached to the image in accordance with a direction from the imaged data reception unit 1112. The image stored in the imaged data storage unit 1114 is referred to by the imaged data transmission unit 1120.

The imaged data request reception unit 1116 receives a request to transmit an image from the user terminal 1030. When the imaged data request reception unit 116 determines that the image is configured to be “restricted” by referring to the imaged data storage unit 1114, the unit 1116 requests the user authentication unit 1118 to determine whether the condition for transmission is met. When the user authentication unit 1118 determines that the condition for transmission is met, or when the imaged data as requested is configured to be “published”, the imaged data request reception unit 1116 requests the imaged data transmission unit 1120 to transmit the requested image.

The user authentication unit 1118 determines whether the user terminal 1030 requesting the transmission of the image meets the condition for transmission, in accordance with the request from the imaged data request reception unit 1116. More specifically, the user authentication unit 1118 extracts the condition for transmission (e.g., the identification information of the user terminal 1030) associated with the target image, by referring to the imaged data storage unit 1114. The information thus extracted represents the identification information of the user terminal 1030 that has requested LOST registration. Alternatively, the user ID may be extracted as the condition for transmission. When the identification information thus extracted matches the identification information included in the request for transmission, the unit 1118 determines that the condition for transmission is met and outputs the result to the imaged data request reception unit 1116. In response to the request from the imaged data request reception unit 1116, the imaged data transmission unit 1120 transmits the image stored in the imaged data storage unit 1114 to the user terminal 1030.

The user control detection unit 1202 comprises buttons etc. and detects the user control. The user control represents directions such as turn-on, turn-off, and imaging. When the user control detected relates to the power supply, the unit 1202 notifies the power control unit 1204 accordingly. The user control related to the power supply represents turn-on and turn-off. The power control unit 1204 receives the detail of the user control related to the power supply from the user control detection unit 1202 and turns on or off the power supply in accordance with the detail detected. Further, the power control unit 1204 requests the device information transmission unit 1206 to transmit the ID when the device 1020 is turned on.

The device information transmission unit 1206 transmits the ID stored in the device information storage unit 1208 to the management device 1010 in accordance with a request from the power supply control unit 1204. In other words, the device information transmission unit 1206 transmits the ID to the management device 1010 when the device 1020 is started. The device information transmission unit 1206 may transmit the ID at a predetermined point of time as well as when the device 1020 is started. The device information storage unit 1208 stores the ID of the imaging device 1020. The unit 1208 also stores transmission permission information related to a condition in which transmission is allowed in the case that the image as uploaded is “restricted”. The ID is referred to by the device information transmission unit 1206 and the transmission permission information is referred to by the imaged data transmission unit 1218.

The loss protection operation direction reception unit 1210 receives a direction for loss protection operation from the management device 1010. The loss protection operation direction reception unit 1210 requests the loss protection operation execution unit 1212 to initiate a loss protection operation. In other words, the loss protection operation direction reception unit 1210 acknowledges a direction, from the management device 1010 to which the device information transmission unit 1206 transmitted the ID, requesting that the image captured by the imaging unit 1216 and stored in the imaged data storage unit 1220 be transmitted and then deleted. As mentioned before, the direction for loss protection operation is generated when it is found in the management device 1010 that the ID of the imaging device 1020 requested to capture an image matches the ID transmitted by the device information transmission unit 1206.

The loss protection operation execution unit 1212 executes a loss protection operation in accordance with a request from the loss protection operation direction reception unit 1210. A loss protection operation is defined as follows. The image as uploaded is forced to be “restricted”. Meanwhile, in the normal operation, the image as uploaded may be configured to be “published” or “restricted” by selection. The image stored in the imaged data storage unit 1220 is uploaded to the management device 1010. When the image is uploaded, the image stored in the imaged data storage unit 1220 is deleted. Further, the detail of user control as detected by the user control detection unit 1202, i.e., the user control acknowledged from the user in control, may be invalidated. The loss protection operation execution unit 1212 directs the upload configuration management unit 1214 and the imaged data storage unit 1220 to execute the above operation.

The upload configuration management unit 1214 manages “published” or “restricted” configurations for upload.

The configuration for upload is used in transmitting the image uploaded to the management device 1010 to the user terminal 1030. When the image is configured to be “published”, the image can be basically transmitted to all user terminals 1030. Meanwhile, when the image is configured to be “non-published”, the image can be transmitted only to those user terminals 1030 that are permitted. The condition imposed on the user terminal 1030 is indicated by the transmission permission information. As mentioned before, the upload configuration management unit 1214 configures an image to be “published” or “restricted” in the normal operation. The unit 1214 configures an image to be “restricted” without exception when the unit 1214 acknowledges a request from the loss protection operation execution unit 1212. When an image is configured to be “restricted”, the ultimate destination of output of the image is restricted to the source of the request to capture images, i.e., the user terminal 1030 requesting the LOST registration. When the user ID is used, the destination may be restricted to the user terminal 1030 logging in using the user ID. The configuration for upload managed by the upload configuration management unit 1214 is referred to when the imaged data transmission unit 1218 transmits the image.

The imaging unit 1216 captures an image when the unit 1216 acknowledges from the user control detection unit 1202 the user control for capturing an image. The imaging unit 1216 stores the captured image in the imaged data storage unit 1220. The imaged data storage unit 1220 is a recording medium for storing an image acknowledged from the imaging unit 1216. The imaged data storage unit 1220 may be detachable from the imaging device 1020 like a memory card. The image stored in the imaged data storage unit 1220 is referred to by the imaged data transmission unit 1218. The imaged data storage unit 1220 deletes the image in response to a request from the loss protection operation execution unit 1212.

The imaged data transmission unit 1218 receives the image from the imaged data storage unit 1220 and transmits the input image to the management device 1010. In this process, the imaged data transmission unit 1218 refers to the upload configuration managed by the upload configuration management unit 1214. When the image is configured to be “published”, the imaged data transmission unit 1218 transmits the image, configuring the image as uploaded to be “published”. Conversely, when the image is configured to be “restricted”, the imaged data transmission unit 1218 appends transmission permission information maintained by the device information storage unit 1208 to the image before transmitting the image to the management device 1010. In a loss protection operation, the imaged data transmission unit 1218 configures the image as uploaded to be “restricted” and automatically transmits the image stored in the imaged data storage unit 1220 to the management device 1010. In a loss protection operation, the loss protection operation execution unit 1212 causes the image stored in the imaged data storage unit 1220 to be deleted when the transmission of the image from the imaged data transmission unit 1218 is completed.

The user control detection unit 1302 detects the user control. For example, when the owner of the imaging device 1020 has lost the imaging device 1020, the user control detection unit 1302 detects the user control related to LOST registration. When the user control detection unit 1302 detects the user control related to LOST registration, the unit 1302 outputs the detail to the LOST registration requesting unit 1304. When the unit 1302 detects the user control requesting transmission of an image, the unit 1302 transmits the detail to the imaged data request transmission unit 1306. When the LOST registration requesting unit 1304 acknowledges the user control related to LOST registration from the user control detection unit 1302, the unit 1304 transmits a request for LOST registration to the management device 1010. The request for LOST registration includes the ID of the target imaging device 1020 and user information such as the user ID and the password. The term “request for LOST registration” encompasses a request for removal from LOST registration.

When the imaged data request transmission unit 1306 acknowledges a request for transmission of an image from the user control detection unit 1302, the unit 1306 requests the management device 1010 to transmit the image. The imaged data reception unit 1308 receives the image transmitted from the management device 1010 in response to the request transmitted by the imaged data request transmission unit 1306. The imaged data reception unit 1308 outputs the image to the display unit 1310. The display unit 1310 displays the image received by the imaged data reception unit 1308.

The configuration is implemented, in hardware, by any CPU of a computer, a memory, or other LSIs and, in software, by a program or the like loaded into the memory. FIG. 2 depicts functional blocks implemented by the cooperation of hardware and software. Therefore, it will be obvious to those skilled in the art that the functional blocks may be implemented in a variety of manners by hardware only, software only, or a combination of thereof.

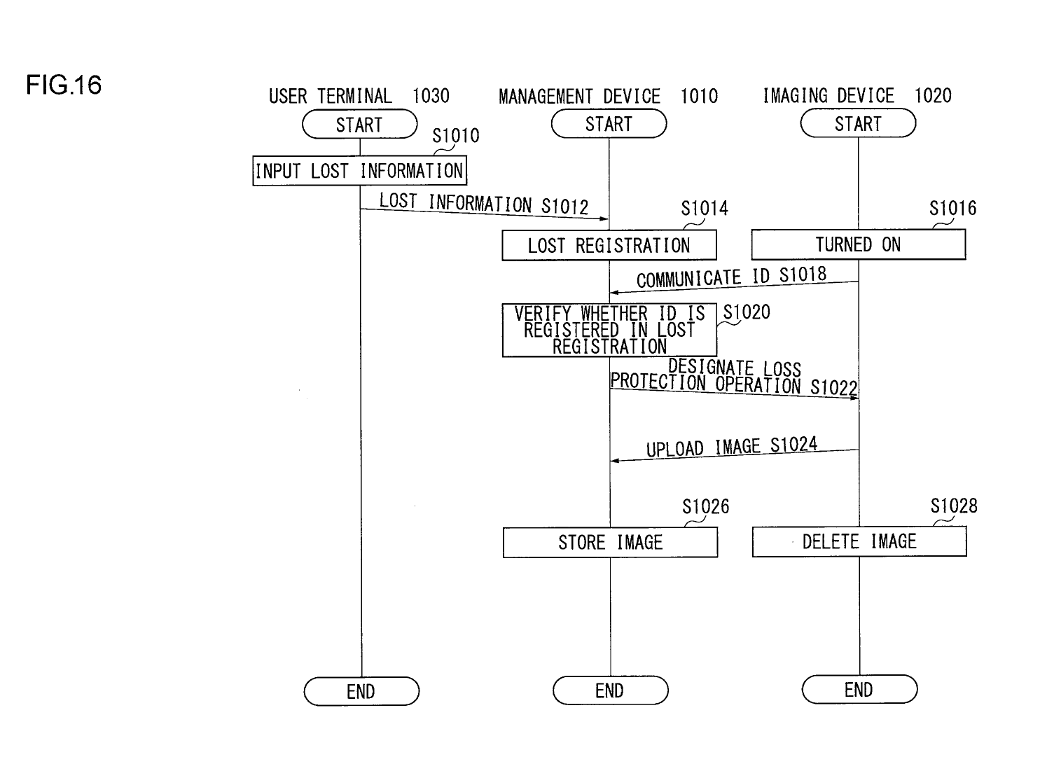

A description will be given of a summary of the operation of the management system 1060 configured as described above. FIG. 16 is a sequence chart showing the process performed by the management system 1060 in the event of a loss of the device. The user terminal 1030 acknowledges an input of LOST information (S1010). The user terminal 1030 transmits the LOST information to the management device 1010 (S1012). The management device 1010 performs LOST registration based on the LOST information (S1014). The imaging device 1020 is started by the finder (S1016). The imaging device 1020 communicates the ID to the management device 1010 (S1018). The management device 1010 verifies whether the ID is registered in LOST registration (S1020). The management device 1010 directs the imaging device 1020 to initiate a loss protection operation (S1022). The imaging device 1020 uploads the images (S1024). The management device 1010 stores the image from the imaging device 1020 (S1026). When the image has been uploaded, the imaging device 1020 deletes the stored image (S1028).

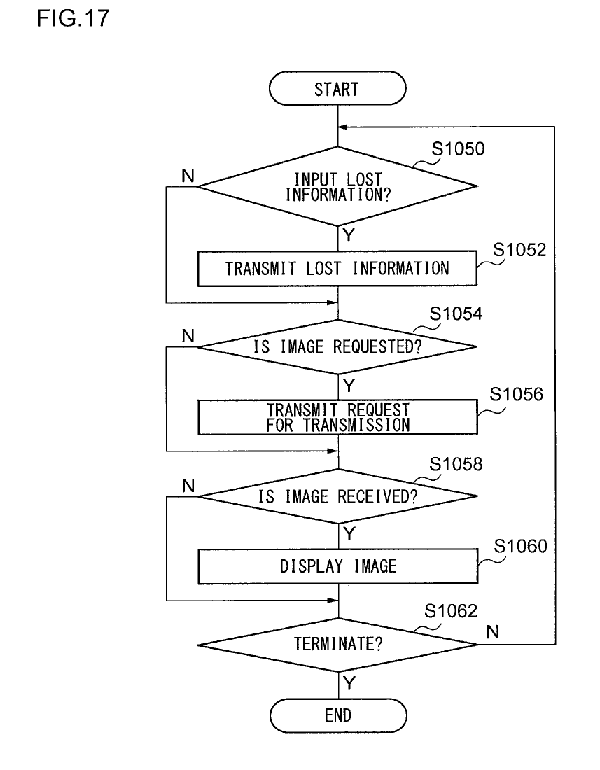

FIG. 17 is a flowchart showing the process by the user terminal 1030 in the event of a loss of the device. When the user control detection unit 1302 acknowledges an input of LOST information (Y in S1050), the LOST registration requesting unit 1304 transmits the LOST information to the management device 1010 (S1052). Conversely, when the user control detection unit 1302 does not acknowledge an input of LOST information (N in S1050), step 1052 is skipped. When the user control detection unit 1302 acknowledges a request for transmission of an image (Y in S1054), the imaged data request transmission unit 1306 transmits a request for transmission to the management device 1010 (S1056). Conversely, when the user control detection unit 1302 does not acknowledge a request for transmission of an image (N in S1054), step 1056 is skipped. When the imaged data reception unit 1308 receives an image from the management device 1010 (Y in S1058), the display unit 1310 displays the image (S1060). Conversely, when the imaged data reception unit 1308 does not receive an image from the management device 1010 (N in S1058), step 1060 is skipped. When the process is not to be terminated (N in S1062), control is returned to step 1050. When the process is to be terminated (Y in S1062), the process is terminated.

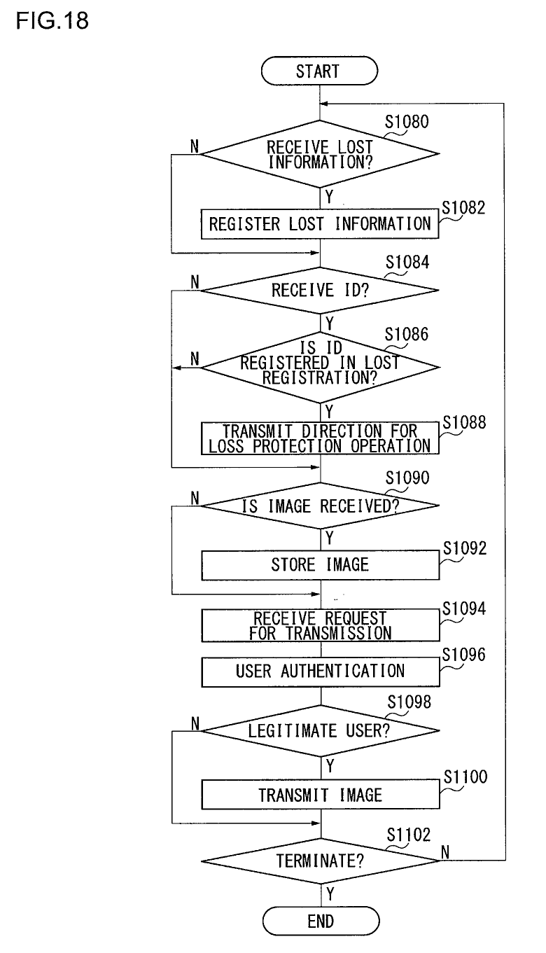

FIG. 18 is a flowchart showing the process performed by the management device 1010 in the event of a loss of the device. When the LOST registration request reception unit 1102 receives LOST information from the user terminal 1030 (Y in S1080), the LOST registration management unit 1104 registers the LOST information (S1082). When the user terminal 1030 originating the request for registration of LOST information is not legitimate, LOST registration is not performed. When the LOST registration request reception unit 1102 does not receive LOST information from the user terminal 1030 (N in S1080), step 1082 is skipped. When the device information reception unit 1106 receives the ID from the imaging device 1020 (Y in 51084) and when the ID is registered in LOST registration (Y in S1086), the loss protection operation direction unit 1110 transmits a direction for loss protection operation (S1088). Conversely, when the device information reception unit 1106 does not receive the ID from the imaging device 1020 (N in S1084), or when the ID is not registered in LOST registration (N in S1086), step 1088 is skipped. When the imaged data reception unit 1112 receives an image from the imaging device 1020 (Y in S1090), the imaged data storage unit 1114 stores the image (S1092).

When the imaged data reception unit 1112 does not receive the image from the imaging device (N in S1090), step 1092 is skipped. The imaged data request reception unit 1116 receives a request for transmission from the user terminal 1030 (S1094). The user authentication unit 1118 performs user authentication to determine whether the source of the request for transmission is a legitimate user (S1096). When the request is from a legitimate user (Y in S1098), the imaged data transmission unit 1120 transmits the image to the user terminal 1030 (S1100). Conversely, when the request is not from a legitimate user (N in S1098), step 1100 is skipped. When the process is not to be terminated (N in S1102), control is returned to step 1080. When the process is to be terminated (Y in S1102), the process is terminated.

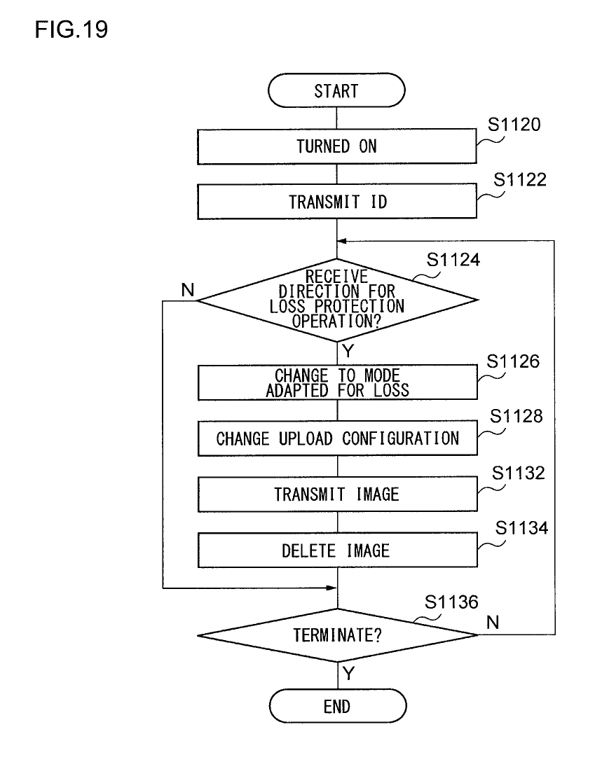

FIG. 19 is a flowchart showing the process executed by the imaging device 1020 in the event of a loss of the device. When the power supply, control unit 1204 detects that the device is turned on (S1120), the device information transmission unit 1206 transmits the ID to the management device 1010 (S1122). When the loss protection direction reception unit 1210 receives a direction for loss protection direction (Y in S1124), the loss protection operation execution unit 1212 changes the operation to a mode adapted for a loss of the device (S1126). The upload configuration management unit 1214 configures images as uploaded to be “restricted” (S1128). The imaged data transmission unit 1218 transmits the image stored in the imaged data storage unit 1220 to the management device 1010 (S1132). The imaged data storage unit 1220 deletes the stored image (S1134). When the loss protection direction reception unit 1210 does not receive a direction for loss protection operation (N in S1124), steps 1126 through 1134 are skipped. When the process is not to be terminated (N in S1136), control is returned to step 1124. When the process is to be terminated (Y in S1136), the process is terminated.

According to the embodiment of the present invention, the imaging device is allowed to capture an image and the image thus captured is acknowledged, and the imaging device is inherently provided with imaging facilities so that the cost is prevented from being increased. By allowing the position where the imaging device is located to be estimated based on the captured image, precision of measurement indoors is prevented from becoming poor. By allowing the imaging device to transmit the ID, the imaging device searched for can be identified easily and accurately. By allowing the position of the imaging device to be estimated based on the captured image, the position of a lost article or a stolen article can be identified, while preventing the cost from being increased and preventing precision of measurement from being degraded. By allowing images to be captured repeatedly, precision of estimating the position is improved. By allowing an image to be captured in response to a direction for capturing and output accordingly, the surrounding situation can be reported in a simple process.

By restricting the ultimate destination of output of the image to the source of request to capture an image, the content of the image is prevented from being published to the general public. By preventing the content of the image from being published to the general public, the one who came into possession of the article accidentally is protected. By transmitting the image to the source of request to capture an image even if the ultimate destination of output of the image is restricted, the image can be made available for view properly. By making the image available for view, the position where the imaging device is can be estimated.

By pixelizing the image acknowledged from the imaging device before transmitting the image, the detail of the image is blurred. By blurring the detail of the image, the one who came into possession of the device accidentally is protected. By blurring the detail of the image, images can be published without exception. By allowing the management device to be responsible for pixelization, the processing load on the imaging device is prevented from being increased. By performing pixelization in accordance with a password known to the source of request to capture an image, the source of request to capture an image can view the image in detail. By allowing the image to be viewed in detail, the position of the imaging device can be estimated at the source of request to capture an image. By transmitting the captured image after pixelizing the image, the detail of the image can be blurred. By allowing the imaging device to be responsible for pixelization, the processing load on the management device is prevented from being increased.

By allowing the imaging device to transmit the image stored in the device, the stored image can be recovered when the imaging device is lost. By allowing the device to delete the image after transmitting the image, the image is prevented from viewed. By allowing the imaging device to transmit the ID, the imaging device monitored can be identified easily and accurately. By restricting the ultimate destination of output of the image to the owner of the image requesting the image or the owner of the imaging device 1020 requesting the image, the content of the image is prevented from being published to the general public. By transmitting the image to the source of request to capture an image even if the ultimate destination of output of the image is restricted, the image can be made available for view properly.

Described above is an explanation based on an exemplary embodiment. The embodiment is intended to be illustrative only and it will be obvious to those skilled in the art that various modifications to constituting elements and processes could be developed and that such modifications are also within the scope of the present invention.

In the embodiment, the destination of transmission of an image is restricted or the image is pixelized. Alternatively, the management device 10 or the imaging device 20 may not restrict the destination of transmission of the image. In this case, the imaged data transmission unit 218 of the imaging device 20 transmits the image captured by the imaging unit 216 to the management device 10. The image as uploaded is configured to be “published”. The imaged data transmission unit 120 of the management device 10 transmits the image in accordance with a direction acknowledged by the imaged data request reception unit 116. According to this variation, the process in the management device 10 and the imaging device 20 is simplified.

What is claimed is:

1. A management device comprising:
a direction input unit adapted to acknowledge a direction to cause an imaging device equipped with communication facilities to capture an image and to acknowledge identification information of the imaging device;
an information input unit adapted to acknowledge, from the imaging device equipped with communication facilities, the identification information of the imaging device via a network;
a direction output unit adapted to direct the imaging device the identification information of which is acknowledged by the information input unit to capture an image in accordance with the direction to capture an image acknowledged by the direction input unit, when the identification information acknowledged by the information input unit matches the identification information acknowledged by the direction input unit;
an image input unit adapted to acknowledge the image from the imaging device directed by the direction output unit to capture an image; and
an image output unit adapted to output the image acknowledged by the image input unit.

2. The management device according to claim 1, wherein
the direction to capture an image provided by the direction output unit directs the imaging device to capture images repeatedly, and
the image input unit acknowledges the images repeatedly captured.

3. An imaging device equipped with communication facilities, comprising:
an information output unit adapted to output identification information of the imaging device to a management device via a network according to a predetermined timing schedule;
a direction input unit adapted to acknowledge a direction to capture an image from the management device to which the information output unit outputs the identification information; and
an imaging unit adapted to capture an image in accordance with the direction acknowledged by the direction input unit; and
an image output unit adapted to output the image captured by the imaging unit to the management device.

4. The imaging device according to claim 3, wherein
the direction to capture an image acknowledged by the direction input unit is generated when it is determined in the management device that the identification information of the imaging device requested to capture an image matches the identification information output by the information output unit.

5. The imaging device according to claim 3, wherein
the direction to capture an image acknowledged by the direction input unit directs the imaging device to capture images repeatedly, and
the imaging unit captures images repeatedly and the image output unit outputs the images repeatedly.

6. An imaging device equipped with communication facilities, comprising:
an information output unit adapted to output identification information of the imaging device to a management device via a network according to a predetermined timing schedule;
a direction input unit adapted to acknowledge a direction to capture an image from the management device to which the information output unit outputs the identification information; and
an imaging unit adapted to capture an image in accordance with the direction acknowledged by the direction input unit; and
an image output unit adapted to output the image captured by the imaging unit to the management device, wherein
the direction to capture an image acknowledged by the direction input unit is generated when it is determined in the management device that the identification information of the imaging device requested to capture an image matches the identification information output from the information output unit, and
the image output unit restricts the destination of output of the image to the source of request to capture an image.

7. The imaging device according to claim 6, wherein
the direction to capture an image acknowledged by the direction input unit directs the imaging device to capture images repeatedly, and
the imaging unit captures images repeatedly and the image output unit outputs the images repeatedly.

8. An imaging method adapted for an imaging device equipped with communication facilities, comprising:
outputting identification information of the imaging device to a management device via a network according to a predetermined timing schedule;
acknowledging a direction to capture an image from the management device to which the identification information is output; and
capturing an image in accordance with the direction thus acknowledged; and
outputting the image thus captured to the management device, wherein
the direction to capture an image as acknowledged is generated when it is determined in the management device that the identification information of the imaging device requested to capture an image matches the identification information of the imaging device as output, and
the outputting restricts the destination of output of the image to the source of request to capture an image.

9. A management device comprising:
a direction input unit adapted to acknowledge a direction to cause an imaging device equipped with communication facilities to capture an image and to acknowledge identification information of the imaging device;
an information input unit adapted to acknowledge, from the imaging device equipped with communication facilities, the identification information of the imaging device via a network;
a direction output unit adapted to direct the imaging device the identification information of which is acknowledged by the information input unit to capture an image in accordance with the direction to capture an image acknowledged by the direction input unit, when the identification information acknowledged by the information input unit matches the identification information acknowledged by the direction input unit;
an image input unit adapted to acknowledge the image from the imaging device directed by the direction output unit to capture an image;
an image processing unit adapted to perform image processing on at least a part of the image acknowledged by the image input unit; and
an image output unit adapted to output the image processed by the image processing unit.

10. The management device according to claim 9, wherein
the direction to capture an image provided by the direction output unit directs the imaging device to capture images repeatedly, and
the image input unit acknowledges the images repeatedly captured.

11. The management device according to claim 9, wherein
the image processing unit performs image processing in accordance with a rule recognized by the source of the direction to capture an image acknowledged by the direction input unit.

12. An imaging device equipped with communication facilities, comprising:
an information output unit adapted to output identification information of the imaging device to a management device via a network according to a predetermined timing schedule;
a direction input unit adapted to acknowledge a direction to capture an image from the management device to which the information output unit outputs the identification information; and
an imaging unit adapted to capture an image in accordance with the direction acknowledged by the direction input unit;
an image processing unit adapted to perform image processing on at least a part of the image captured by the imaging unit; and
an image output unit adapted to output the image processed by the image processing unit to the management device.

13. The imaging device according to claim 12, wherein
the direction to capture an image acknowledged by the direction input unit is generated when it is determined in the management device that the identification information of the imaging device requested to capture an image matches the identification information output from the information output unit.

14. A management device comprising:
a first input unit adapted to acknowledge identification information of an imaging device equipped with communication facilities and subject to monitoring, from a communication device via a network;
a second input unit adapted to acknowledge identification information of an imaging device equipped with communication facilities from the imaging device via a network;
a direction output unit adapted to cause the imaging device, the identification information of which is acknowledged by the second input unit, to transmit a stored image and then delete the stored image, when the identification information acknowledged by the second input unit matches the identification information acknowledged by the first input unit;
an image input unit adapted to acknowledge the image from the imaging device caused by the direction output unit to transmit the image; and
a storage control unit adapted to cause the image acknowledged by the image input unit to store the image in a recording medium.

15. An imaging device equipped with communication facilities, comprising:
an imaging unit;
an information output unit adapted to output identification information of the imaging device to a management device via a network according to a predetermined timing schedule;
a direction input unit adapted to acknowledge a direction to transmit an image captured by the imaging device and stored therein and then to delete the image, from the management device to which the information output unit outputs the identification information;
an image output unit adapted to transmit the stored image to the management device in accordance with the direction acknowledged by the direction input unit; and
a deletion unit adapted to delete the image after the image is transmitted from the image output unit.

16. An imaging device equipped with communication facilities, comprising:
an imaging unit;
a direction input unit adapted to acknowledge a direction from a management device requesting that an operation adapted for loss of the device should be performed; and
an execution unit adapted to execute the operation adapted for loss of the device in accordance with the direction acknowledged by the direction input unit.
